(19) United States
(12) Patent Application Publication
(10) Pub. No.: US 2012/0188769 A1
(43) Pub. Date: Jul. 26, 2012

(54) INDUCTION LIGHTING LUMINAIRE INSTALLATION

(76) Inventor: Kenneth Lau, Carlsbad, CA (US)

(21) Appl. No.: 13/352,309

(22) Filed: Jan. 17, 2012

Related U.S. Application Data
(60) Provisional application No. 61/434,520, filed on Jan. 20, 2011.

(51) Int. Cl. F21V 21/26; B23P 6/00

(52) U.S. Cl. 362/269; 29/402.08

(57) ABSTRACT

A new method and apparatus for installing replacement induction lamp envelopes into cobra-head lighting fixtures is presented, using a novel split reflector design that permits easy access to the lamp envelope compartment.

### RELATED APPLICATIONS

This application claims the benefit of U.S. Provisional Application 61/434,520 dated Jan. 20, 2011, whose contents are included by reference.

### FIELD OF THE INVENTION

This invention is related to the field of induction lighting, used in both outdoor and indoor lighting.

### BACKGROUND OF THE INVENTION

Induction lighting systems can last approximately 100,000 hours before replacement. They are used in applications such as street lighting fixtures that are generally described as a “cobra head”, because of their shape.

The typical street light cobra head arrangement accommodates a screw-in discharge bulb inserted into a lampholder. The proposed retrofit for these light systems involves substituting an induction lamp, a power coupler, and a high-frequency ballast. As the standard cobra-head enclosure is too short to make retrofit installation possible, a new enclosure is proposed to allow easy retrofit and replacement of the induction lamp system

### OBJECTS OF THE INVENTION

It is an object of the present invention to provide a modified induction lighting luminaire enclosure.

It is the object of the present invention that the induction light luminaire enclosure be constructed with a split reflector.

It is a further object of this invention that said split reflector be opened by means of a hinge or by sliding out of the split reflector.

### BRIEF DESCRIPTION OF THE FIGURES

FIG. 1. Reflector and HID lamp

FIG. 2. Cross-section of discharge lamp with bulb out

FIG. 3. Cross-section of discharge lamp with bulb inserted

FIG. 4. Induction lamp system

FIG. 5. Typical Cobra Head Reflector

FIG. 6. Split Reflector

FIG. 7. Open Fixture Housing

FIG. 8. Closed Fixture Housing

### DETAILED DESCRIPTION

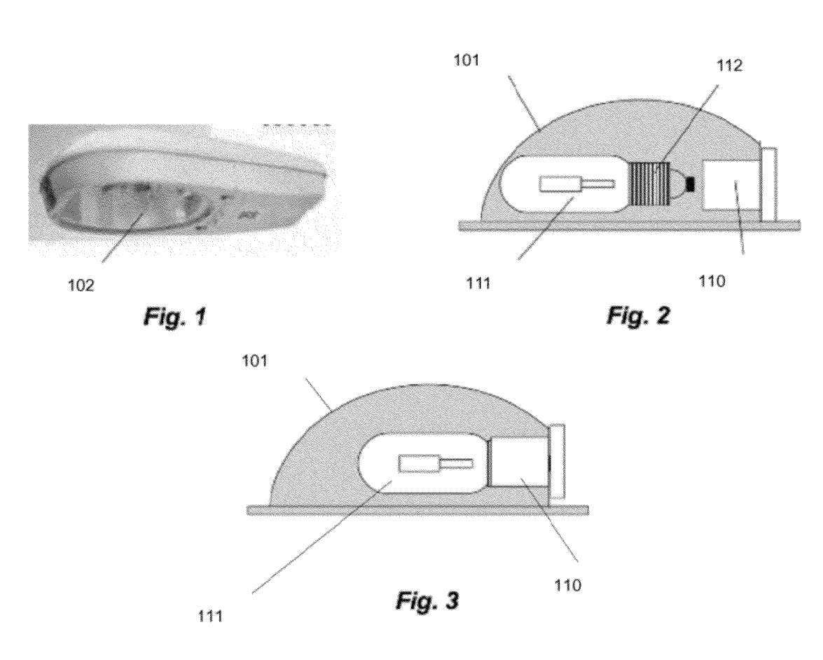

FIG. 1 through FIG. 3 show the general configuration of a cobra head discharge lamp lighting fixture 100. There is an upper housing 101 that contains an interior socket structure 110 within which a lamp 111 or light bulb can be mounted, ordinarily screwed into said socket 110 by means of screw threads 112. The street lighting fixture is closed by a transparent or translucent lens 102.

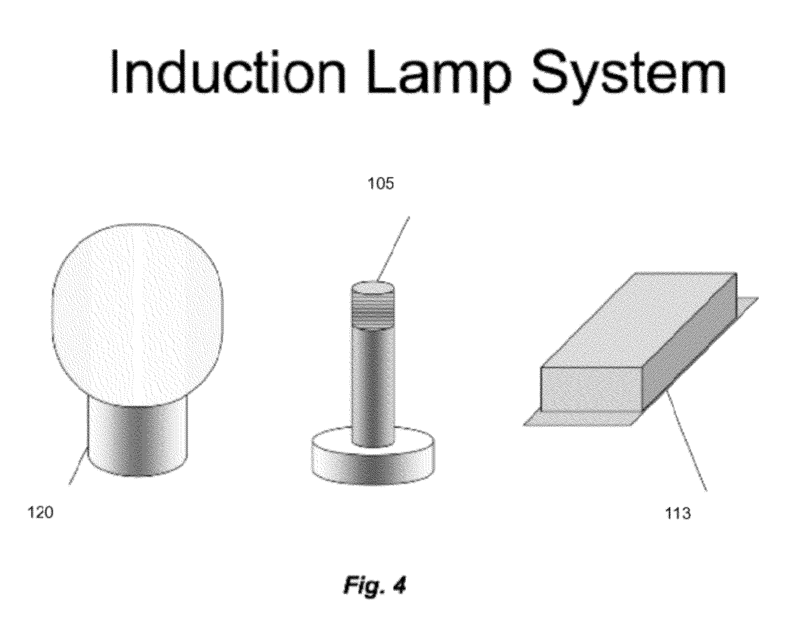

FIG. 4 shows the induction lamp system, including an induction lamp envelope 120, a power coupler 105 and a high-frequency ballast 113. There are other lamp shapes and configurations possible. These are the basic components of any induction lamp.

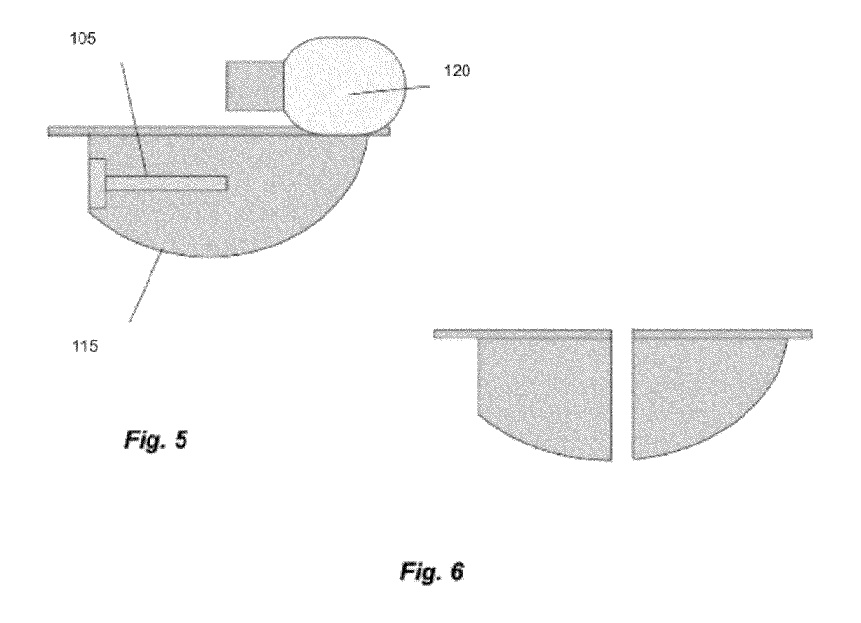

FIG. 5 shows a cobra head lamp enclosure 115 with a power coupler 105 installed. From inspection, the induction lamp envelope 120 cannot be easily installed within the enclosure 115 due to the power coupler 105 length. The enclosure 115 has to be removed or the power coupler 105 removed from the enclosure 115 to permit lamp 120 replacement

In FIG. 6, the split cobra head reflector is shown.

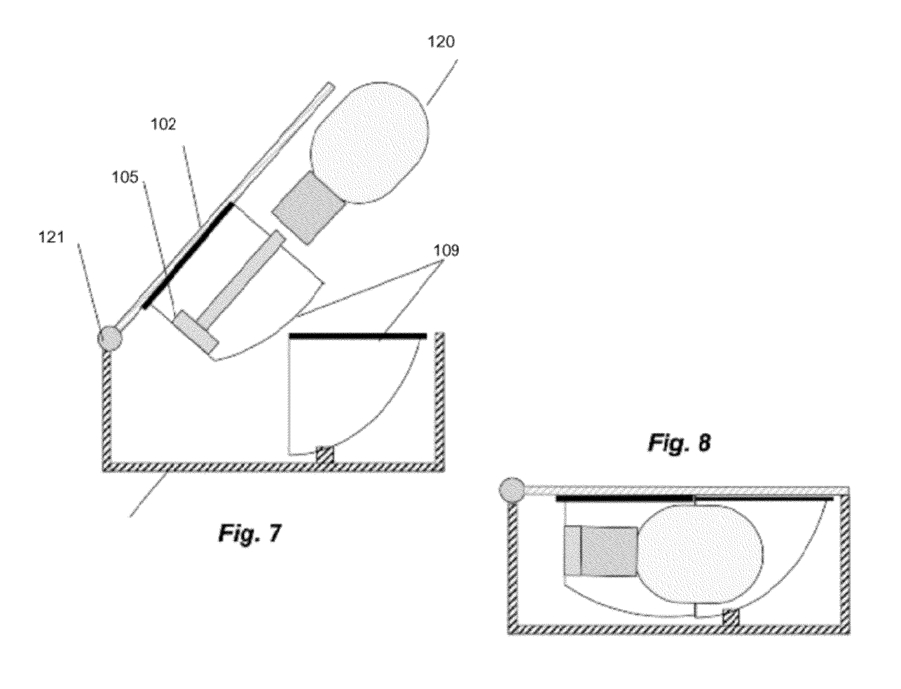

FIG. 7 shows the preferred embodiment of the invention, comprised of a hinged lens 110 with attached split reflector 109 and coupler 105 that can be swung up via the hinge 121 to permit installation of the induction lamp envelope 120, then swung back down to complete the installation and close the cobra head enclosure 115 as in FIG. 8.

An alternate embodiment of the invention would permit the split reflector 109 to be slid off the end of the cobra head enclosure 115 after the hinge 121 is swung up.

While the foregoing describes a preferred and an alternative embodiment of the invention, variation on this design and equivalent designs may be resorted to in the scope and spirit of the claimed invention.

What is claimed is:

1. An induction lighting and lamp installation system, the induction lighting system comprised of an induction lamp envelope, a power coupler, and a high-frequency ballast,
the lamp installation system comprised of a lamp enclosure with a power coupler and a high frequency ballast installed within it, a split reflector, and a hinge,
one half of the split reflector containing the coupler and ballast and capable of being swung up via the hinge, the resulting opening in the lamp enclosure large enough to permit the mating of the induction lamp envelope with the power coupler.

2. The induction lighting and lamp installation system of claim 1 where the second half of the split reflector can be slid off the end of the lamp enclosure permitting installation of the induction lamp envelope with the power coupler.

3. A method of installing a replacement induction lamp envelope in a lamp enclosure in an induction lighting system as in claim 1 comprised of the steps of
opening the lamp enclosure by rotating half of the split reflector on the hinge,
removing the old induction lamp envelope from the power coupler,
placing a new induction lamp envelope over the power coupler,
closing the lamp enclosure by rotating the split reflector back into the lamp enclosure and latching it.
